(19) United States
(12) Patent Application Publication
(10) Pub. No.: US 2014/0146171 A1
(43) Pub. Date: May 29, 2014

(54) Surveillance and Security Communications Platform

(71) Applicant: MICROSOFT CORPORATION, Redmond, WA (US)

(72) Inventors: Fernmarie Brady, Issaquah, WA (US); Gunter Leeb, Redmond, WA (US)

(73) Assignee: MICROSOFT CORPORATION, Redmond, WA (US)

(21) Appl. No.: 13/685,589

(22) Filed: Nov. 26, 2012

(51) Int. Cl. H04N 7/18

(52) U.S. Cl. CPC H04N 7/188
USPC 348/143

(57) ABSTRACT

A surveillance and security communications platform for detecting and responding to potential emergencies is provided. The platform may be utilized to automatically open communications channels via multiple media streams based on predefined settings for detecting a potential emergency situation. The platform may further be utilized to automatically send video and audio streams to an emergency responder upon detecting the potential emergency situation. The platform may further be utilized to detect the potential emergency situation while it is occurring and automatically initiate escalated emergency notifications to multiple parties. The platform may further be utilized to receive computing device sensor data for detecting the potential emergency for a potential victim in a business or home setting and immediately send an emergency notification, which may include a predefined text-to-speech announcement, to emergency responders in order to mitigate the potential emergency.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Surveillance and security systems are commonly used in homes and businesses to provide assistance in reacting to various emergency or potential emergency situations. Traditional systems however, suffer from a number of drawbacks. In particular, with respect to the detection of potential emergencies, previous solutions offered by traditional systems are typically expensive and/or highly dependent on human intervention or human reaction in order to contact emergency services. Thus, these systems are ineffective when a human victim is not able to seek help, is unconscious, or is simply not aware of the potential emergency. For example, the LIFEALERT medical alert system and services offer a paid by month service that consists of a pendant-shaped device which is worn on a necklace or wristband. The device features an automated dialer that is connected to a public switched telephone network (“PSTN”) telephone line. When a person (e.g., an elderly or disabled person) falls down and is unable to get up, or in the event of a similar emergency, a telephone line may be out of reach, but the victim may use the pedant to contact emergency services. A drawback with the aforementioned system however, is that the associated service assumes that the person experiencing the emergency will be in a conscious or otherwise lucid state in order to use the pendant for contacting emergency services. As another example, many traditional home surveillance system setups require or encourage the use of a combination of multiple cameras, motion sensors and digital recorders equipped with automated software that analyzes footage or transmits footage to a security operator in real time. However, home surveillance systems can easily become very expensive for the average homeowner depending on the setup complexity and architecture. In particular, many home surveillance systems with sophisticated settings and multiple cameras can costs thousands of dollars and are often underutilized, making them expensive and costly to maintain for the average homeowner. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for detecting and responding to potential emergencies using a surveillance and communications platform. The platform may be utilized to automatically open communications channels via multiple media streams based on predefined settings for detecting a potential emergency situation. The platform may further be utilized to automatically send video and audio streams to an emergency responder upon detecting the potential emergency situation. The platform may further be utilized to detect the potential emergency situation while it is occurring and automatically initiate escalated emergency notifications to multiple parties. The platform may further be utilized to receive computing device sensor data for detecting the potential emergency for a potential victim in a business or home setting and immediately send an emergency notification, which may include a predefined text-to-speech announcement, to emergency responders in order to mitigate the potential emergency. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture which may be utilized for detecting and responding to potential emergencies using a surveillance and communications platform, in accordance with various embodiments;

FIG. 2 is a flow diagram illustrating a routine for utilizing a surveillance and security communications platform for automatically communicating emergency situation data to an emergency responder, in accordance with an embodiment;

FIG. 3 is a flow diagram illustrating a routine for utilizing a surveillance and security communications platform for emergency call escalation, in accordance with an embodiment;

FIG. 4 is a flow diagram illustrating a routine for utilizing a surveillance and security communications platform for emergency detection and notification, in accordance with an embodiment;

FIG. 5 is a simplified block diagram of a computing device with which various embodiments may be practiced;

FIG. 6A is a simplified block diagram of a mobile computing device with which various embodiments may be practiced; and

FIG. 6B is a simplified block diagram of a mobile computing device with which various embodiments may be practiced.

### DETAILED DESCRIPTION

Embodiments are provided for detecting and responding to potential emergencies using a surveillance and communications platform. The platform may be utilized to automatically open communications channels via multiple media streams based on predefined settings for detecting a potential emergency situation. The platform may further be utilized to automatically send video and audio streams to an emergency responder upon detecting the potential emergency situation. The platform may further be utilized to detect the potential emergency situation while it is occurring and automatically initiate escalated emergency notifications to multiple parties. The platform may further be utilized to receive computing device sensor data for detecting the potential emergency for a potential victim in a business or home setting and immediately send an emergency notification, which may include a predefined text-to-speech announcement, to emergency responders in order to mitigate the potential emergency.

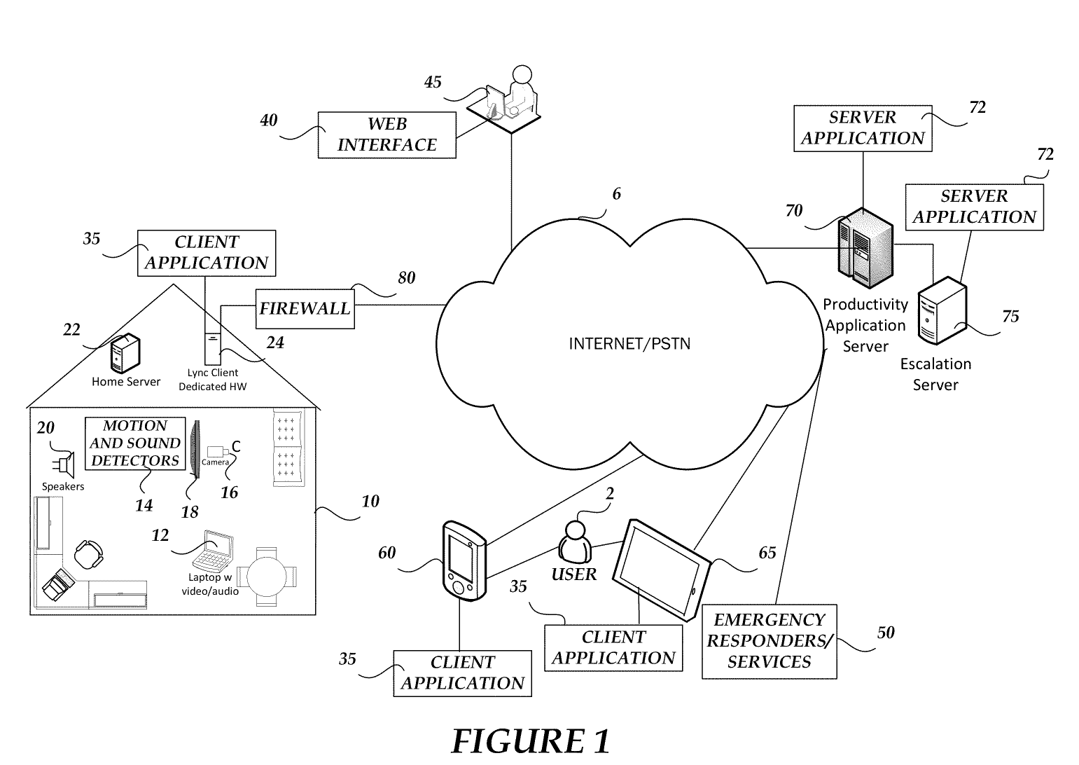

FIG. 1 is a block diagram illustrating a network architecture which may be utilized for detecting and responding to potential emergencies using a surveillance and communications platform, in accordance with various embodiments. The network architecture includes a productivity application server 70 in communication with an escalation server 75. The servers 70 and 75 are in communication with a client computing device 24 over a network (i.e., Internet/PSTN) 6 through a firewall 80. The client computing device 24 is located within a premises 10 which may, for example, comprise a home or business. The network architecture also includes mobile computing devices 60 and 65 which may be utilized by a user 2. In accordance with an embodiment, the mobile computing devices 60 and 65 may comprise a smartphone and a tablet computing device, respectively. The network architecture further includes emergency responders/services 50. In accordance with various embodiments the emergency responders/services 50 may comprise fire, medical and/or law enforcement services which may be contacted in the event of an emergency (i.e., professional emergency responders). The network architecture further includes a client computing device 45 from which a user may utilize a web interface 40 for controlling authentication settings and configuring surveillance options with respect to the premises 10. In accordance with an embodiment, the web interface 40 may be utilized by an owner or authorized users of the premises 10 to access a premises network by sending in instant messaging (“IM”) message to the client computing device 24.

In addition to the client computing device 24, the premises 10 may further include a home server 22, speakers 20, motion and sound detectors 14, a client computing device 12, a video display 18 and a camera 16. The home server 22 may store and execute software applications which may be utilized by any of the devices in the premises 10 (e.g., the client computing device 12, the motion and sound detectors 14, etc.). In accordance with an embodiment the motion and sound detectors 14 may comprise the KINECT motion sensing input device from MICROSOFT CORPORATION of Redmond, Wash. It should be understood, however, that other motion and sound detectors from other manufacturers may alternatively be utilized in accordance with the various embodiments described herein. The camera 16 and the video display 18 may be used in conjunction with software executing on the home server 22 for conducting real-time (or near real-time) video and communications as well as for providing instant messaging functionality with the outside world (including the emergency responders/services 50). In accordance with an embodiment, the software for conducting the video and audio communications may comprise the SKYPE voice-over-Internet Protocol (“VoIP”) service from MICROSOFT CORPORATION of Redmond, Wash. It should be understood, however, that other communications software from other manufacturers may alternatively be utilized in accordance with the various embodiments described herein. In accordance with an embodiment, the client computing device 24 may comprise a dedicated (“always-on”) hardware device that remains active twenty-four hours a day. The client computing device 24 may include client application 35 which may be utilized for providing surveillance/security functionality for the rest of the network (i.e., the motion and sound detectors 14, the client computing device 12 and the home server 22) in the premises 10. In accordance with an embodiment, the client application 35 may comprise the LYNC client communications platform software from MICROSOFT CORPORATION of Redmond, Wash.

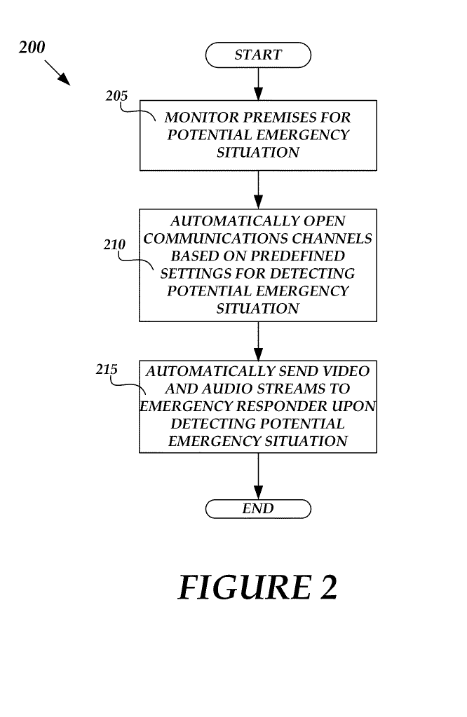

The servers 70 and 75 may both include server application 72 which may be utilized for providing surveillance/security functionality in conjunction with the client application 35. As will be described in greater detail below in the discussion FIGS. 2-4, the surveillance/security functionality may include escalated emergency notifications (i.e., call escalation), sending video/audio feeds during potential emergency situations to emergency responders, enabling the use of mobile computing device (e.g., smartphone and tablet) sensors to detect potential emergencies and immediately send out emergency notifications to mitigate potential emergencies without human intervention. In accordance with an embodiment, the server application 72 may comprise a unified communications platform which may include, but is not limited to, functionality for instant messaging, presence, file transfer, peer-to-peer and multiparty voice and video calling, ad hoc and structured conferences (audio, video and web) and public switched telephone network (“PSTN) connectivity. An illustrative unified communications platform which may be utilized with the various embodiments described herein is the LYNC SERVER enterprise-ready unified communications platform software from MICROSOFT CORPORATION of Redmond, Wash. It should be understood, however, that other communications platform software from other manufacturers may alternatively be utilized in accordance with the various embodiments described herein.

The mobile computing devices 60 and 65 may include instances of the client application 35 which, as described above, may be utilized for providing surveillance/security functionality. With respect to the aforementioned mobile computing devices, the client application 35 may be utilized for receiving mobile computing device sensor data (e.g., from gyroscope sensors that detect three-axis angular acceleration and accelerometer sensors that can detect shake, shock or fall) and using this sensor data to help identify whether an emergency may be occurring (such as a fall). As discussed above, and in accordance with an embodiment, the client application 35 may comprise the LYNC client communications platform software from MICROSOFT CORPORATION of Redmond, Wash.

FIG. 2 is a flow diagram illustrating a routine 200 for utilizing a surveillance and security communications platform for automatically communicating emergency situation data to an emergency responder, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 2-4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 200 begins at operation 205, where the client application 35, executing on the client computing device 24, may monitor a premises for a potential emergency situation. In particular, the client application 35 may communicate with the motion and sound detectors 14 as well as the camera 16 in the premises 10 to help determine whether an emergency situation is occurring with respect to one or more occupants (not shown). For example, the motion and sound detectors 14 may be utilized to identify a person approaching a window from outside of the premises 10 and the camera 16 may be utilized to detect motion inside of the premises during a time period when the occupants are away. Thus, it should be understood that the aforementioned detection devices, which are configured to both detect motion and video/audio as well as communicate the detection data to the client computing device 24 (which in turn may store the detection data in the network 6), may be utilized (for example) to detect erratic movements (e.g., a person lying on the floor with their hands in the air), non-customary disruptions (e.g., glass breakage, metal stress, wood breakage, gunshots, etc.) or specific gestures (e.g., assault, violence, etc.) which may be indicative of a robbery situation occurring inside the premises 10.

From operation 205, the routine 200 continues to operation 210, where the client application 35, executing on the client computing device 24, may automatically open communications channels based on predefined settings for detecting a potential emergency situation. In particular, upon receiving motion and video/audio data that a potential emergency (e.g., a robbery) may be occurring in the premises 10, the client application 35 may be configured to automatically open one or multiple communications channels via any media stream (i.e., voice, IM, video, etc.) based on predefined settings made in the web interface 40. The predefined settings may include opening the communications channels upon detecting the occurrence of erratic movements (e.g., a person lying on the floor with their hands in the air), non-customary disruptions (e.g., glass breakage, metal stress, wood breakage, gunshots, etc.) or specific gestures (e.g., assault, violence, etc.) which may be indicative of a robbery situation occurring inside the premises 10.

From operation 210, the routine 200 continues to operation 210, where the client application 35, executing on the client computing device 24, may automatically send video and audio streams to an emergency responder upon detecting the potential emergency situation. In particular, the client computing device 24, may automatically send the video/audio data collected from the motion and sound detectors 14 and the camera 16 to the escalation server 75 which in turn (utilizing the server application 72) may contact the emergency responders/services 50 (e.g., the police in the circumstance of a robbery situation). It should be appreciated that, in accordance with the embodiments described herein, an emergency responder may receive the video and audio streams while the potential emergency is still taking place. From operation 215, the routine 200 then ends.

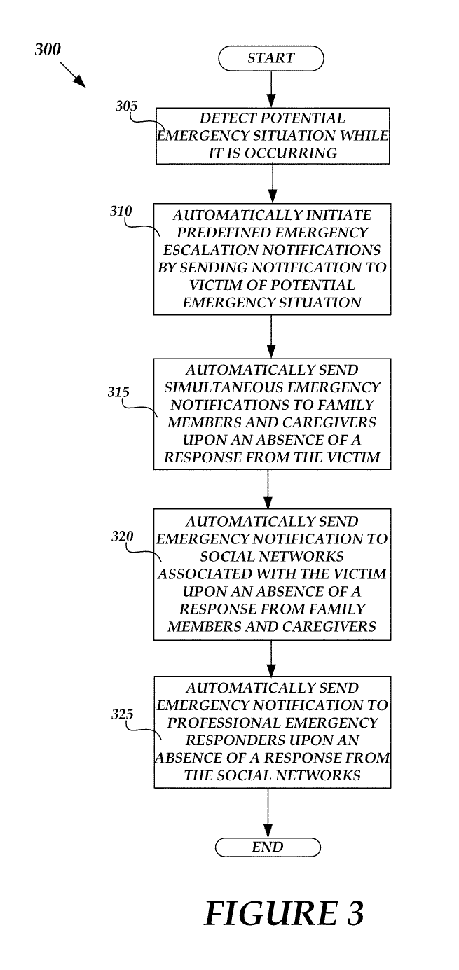

FIG. 3 is a flow diagram illustrating a routine 300 for utilizing a surveillance and security communications platform for emergency call escalation, in accordance with an embodiment. The routine 300 begins at operation 305 where the client application 35 which, for example, may be executing on the mobile computing devices 60 or 65, may be utilized to detect a potential emergency situation while it is occurring. In particular, the client application 35 may be configured to utilize sensors (e.g., gyroscope and accelerometer sensors) in the a mobile computing device to detect abrupt movements indicative of an emergency such as shaking, a shock or a fall, associated with the user 2, and communicate the sensor data to the escalation server 75.

From operation 305, the routine 300 continues to operation 310, where the client application 35 may automatically initiate a series of predefined emergency escalation notifications, beginning with sending a notification to the victim of a potential emergency situation. For example, if the client application 35 detects a fall may have occurred to the user 2 who is associated with the mobile computing device 60, the server application 72 executing on the escalation server 75 may use a bot to automatically attempt to reach the victim (as a precautionary measure) via any of a number of available communication methods. If the bot is able to reach the victim, no further action is required.

From operation 310, the routine 300 continues to operation 315, wherein the server application 72, executing on the escalation server 75, may be configured to automatically send simultaneous emergency notifications to family members and caregivers upon an absence of a response from the victim to the notification sent at operation 305. In particular, the original notification may be “escalated.” For example, the server application 72 may be configured to initiate simultaneously telephone calls to contact family members or caregivers associated with the user 2 (i.e., the victim). It should be appreciated that, in accordance with various embodiments, the server application 72 may be configured to reach multiple telephone numbers simultaneously (e.g., family members' cell phones, work phones, vacation home phones, etc.) and/or simultaneously activate multiple communication media streams (e.g., make a telephone call and send a Short Message Service (“SMS”) message and send an IM message, and send an electronic mail (“e-mail”) message, etc. It should be understood that the server application 72 may be configured by an end user to define a number of rings before escalating the communication (e.g., before reaching out to social networks or to professional emergency responders). It should be further understood that the server application 72 may be configured to place a conference call instead of making individual calls (e.g., a first conference call may be initiated to family members for an ad-hoc family meeting and then, if there is not response after a predetermined number of rings, a subsequent conference call may be initiated which includes social network contacts). It should be further understood that the server application 72 may be configured such that a user (i.e., a potential victim) may pre-record and/or change an automated voice message, as well as generate a written message that will be used as the content of an emergency notification sent to others during a potential emergency situation. It should be further understood that when attempting to send a notification to family members or caregivers via telephone, the server application 72 may be configured to recognize when it reaches voicemail and a user may configure the server application 72 to leave a message or not based on user preference. The server application 72 may also be configured to track all call recordings and usage logs.

From operation 315, the routine 300 continues to operation 320, wherein the server application 72, executing on the escalation server 75, may be configured to automatically send an emergency notification to social networks associated with the victim upon an absence of a response from family members and caregivers to the notification sent at operation 310.

From operation 320, the routine 300 continues to operation 325, wherein the server application 72, executing on the escalation server 75, may be configured to automatically send an emergency notification to professional emergency responders upon an absence of a response from the social networks to the notification sent at operation 315. In particular, the server application 72 may be configured to contact a professional emergency responder (e.g., fire, medical, law enforcement services, etc.) who may be reached (either individually or simultaneously) and dispatched to assist the victim. For example, in accordance with an embodiment, the server application 72 may be configured to supply E-911 location information to the professional emergency responders for locating the victim. In accordance with an embodiment, a professional emergency responder may also attempt to reach the victim by dialing the victim's telephone number retrieved from a caller ID. It should be appreciated that the escalation operations 315-325, discussed above, may all occur within minutes of a potential emergency situation. From operation 325, the routine 300 then ends.

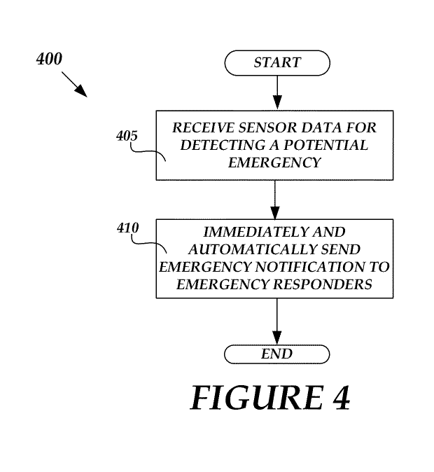

FIG. 4 is a flow diagram illustrating a routine 400 for utilizing a surveillance and security communications platform for emergency detection and notification, in accordance with an embodiment. The routine 400 begins at operation 405 where the client application 35 which may be executing on the mobile computing devices 60 or 65, or executing on the client computing device 24 in the premises 10, may be utilized to receive sensor data for detecting a potential emergency. In particular, the client application 35 may be configured to receive motion and sound detector data and video data in the premises 10 (e.g., from the motion and sound detectors 14 and the camera 16) or gyroscope and accelerometer sensor data from the mobile computing devices 60 or 65. For example, the client application 35 may be configured to utilize sensors (e.g., gyroscope and accelerometer sensors) in a mobile computing device to detect abrupt movements indicative of an emergency such as shaking, a shock or a fall, associated with the user 2. As another example, the aforementioned sensor data may be utilized to detect potentially violent gestures (e.g., assault, violence, etc.) in a business setting or a potential intrusion (e.g., breaking glass, gunshots, etc.) in a home setting. Thus, it should be appreciated that, in accordance with an embodiment, sensor data may be utilized to recognize a cry for help from a potential victim.

From operation 405, the routine 400 continues to operation 410 where the client application 35 may be utilized to immediately and automatically send an emergency notification to multiple recipients in order to notify a potential emergency to the general community, thereby mitigating the potential emergency without human intervention. In accordance with an embodiment, the client application 35 may communicate the received sensor data to the server application 72 on the escalation server 75 which may then send out a user predefined text-to-speech announcement, to emergency responders. From operation 410, the routine 400 then ends.

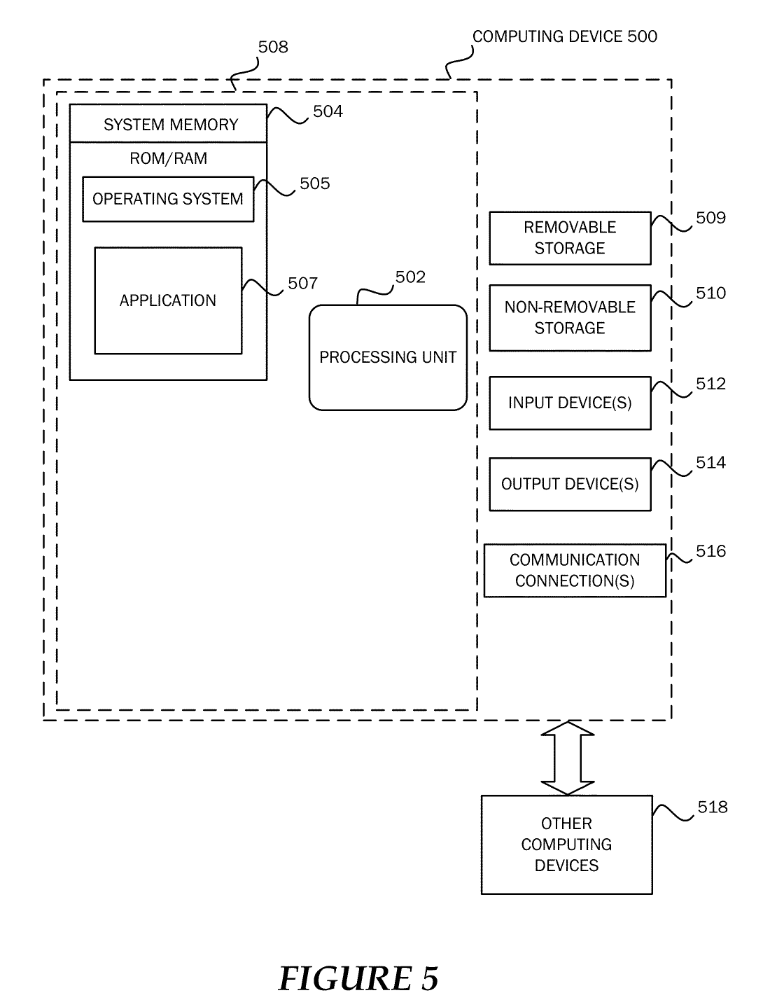

FIG. 5 is a block diagram illustrating example physical components of a computing device 500 with which various embodiments may be practiced. The computing device components described below may be suitable for the servers 22, 70 and 75 as well as the client and mobile computing devices 12, 24, 45, 60 and 65, each of which was described above with respect to FIG. 1. In a basic configuration, the computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include an operating system 505 and applications 507. Operating system 505, for example, may be suitable for controlling computing device 500's operation and, in accordance with an embodiment, may comprise the WINDOWS operating systems from MICROSOFT CORPORATION of Redmond, Wash. It should be understood that the embodiments described herein may also be practiced in conjunction with other operating systems and application programs and further, is not limited to any particular application or system.

The computing device 500 may have additional features or functionality. For example, the computing device 500 may also include additional data storage devices (removable and/or non-removable) such as, for example, magnetic disks, optical disks, solid state storage devices (“SSD”), flash memory or tape. Such additional storage is illustrated in FIG. 5 by a removable storage 509 and a non-removable storage 510.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 500 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500.

The computing device 500 may also have input device(s) 512 such as a keyboard, a mouse, a pen, a sound input device (e.g., a microphone) for receiving a voice input, a touch input device for receiving gestures, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

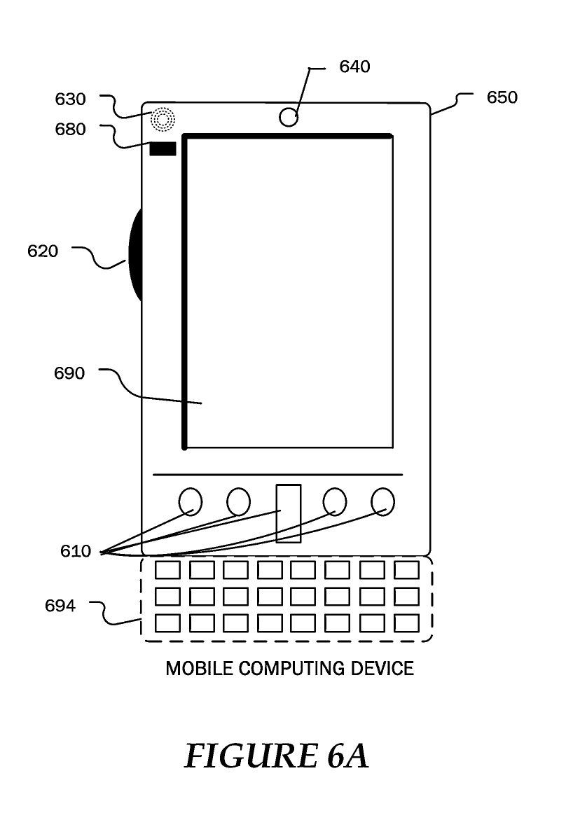

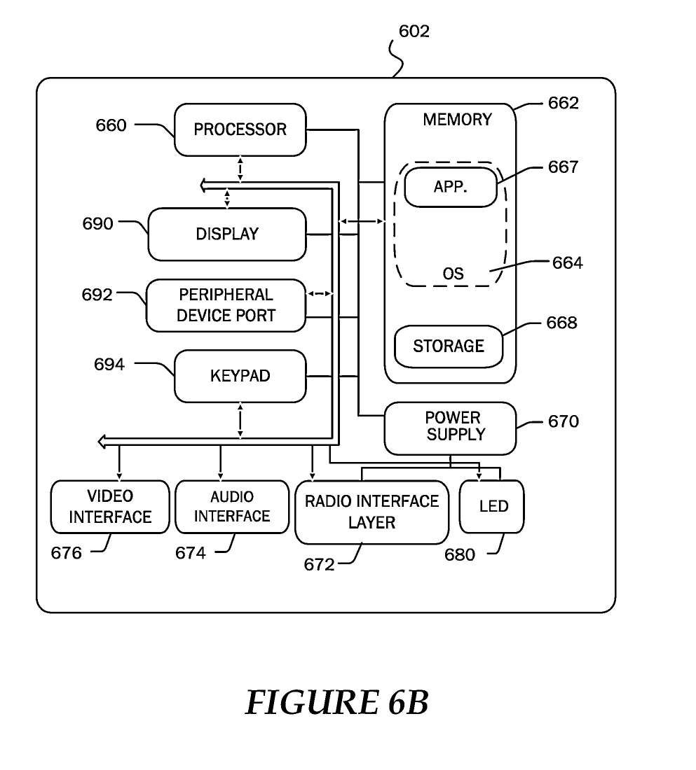

FIGS. 6A and 6B illustrate a suitable mobile computing environment, for example, a mobile computing device 650 which may include, without limitation, a smartphone, a tablet personal computer, a laptop computer, and the like, with which various embodiments may be practiced. With reference to FIG. 6A, an example mobile computing device 650 for implementing the embodiments is illustrated. In a basic configuration, mobile computing device 650 is a handheld computer having both input elements and output elements. Input elements may include touch screen display 625 and input buttons 610 that allow the user to enter information into mobile computing device 650. Mobile computing device 650 may also incorporate an optional side input element 620 allowing further user input. Optional side input element 620 may be a rotary switch, a button, or any other type of manual input element. In alternative embodiments, mobile computing device 650 may incorporate more or less input elements. For example, display 625 may not be a touch screen in some embodiments. In yet another alternative embodiment, the mobile computing device is a portable telephone system, such as a cellular phone having display 625 and input buttons 610. Mobile computing device 650 may also include an optional keypad 605. Optional keypad 605 may be a physical keypad or a “soft” keypad generated on the touch screen display.

Mobile computing device 650 incorporates output elements, such as display 625, which can display a graphical user interface (GUI). Other output elements include speaker 630 and LED 680. Additionally, mobile computing device 650 may incorporate a vibration module (not shown), which causes mobile computing device 650 to vibrate to notify the user of an event. In yet another embodiment, mobile computing device 650 may incorporate a headphone jack (not shown) for providing another means of providing output signals.

Although described herein in combination with mobile computing device 650, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 6B is a block diagram illustrating components of a mobile computing device used in one embodiment, such as the mobile computing device 650 shown in FIG. 6A. That is, mobile computing device 650 can incorporate a system 602 to implement some embodiments. For example, system 602 can be used in implementing a “smart phone” that can run one or more applications similar to those of a desktop or notebook computer. In some embodiments, the system 602 is integrated as a computing device, such as an integrated personal digital assistant (PDA) and wireless phone.

Applications 667 may be loaded into memory 662 and run on or in association with an operating system 664. The system 602 also includes non-volatile storage 668 within memory the 662. Non-volatile storage 668 may be used to store persistent information that should not be lost if system 602 is powered down. The applications 667 may use and store information in the non-volatile storage 668. A synchronization application (not shown) also resides on system 602 and is programmed to interact with a corresponding synchronization application resident on a host computer to keep the information stored in the non-volatile storage 668 synchronized with corresponding information stored at the host computer. As should be appreciated, other applications may also be loaded into the memory 662 and run on the mobile computing device 650.

The system 602 has a power supply 670, which may be implemented as one or more batteries. The power supply 670 might further include an external power source, such as an AC adapter or a powered docking cradle that supplements or recharges the batteries.

The system 602 may also include a radio 672 (i.e., radio interface layer) that performs the function of transmitting and receiving radio frequency communications. The radio 672 facilitates wireless connectivity between the system 602 and the “outside world,” via a communications carrier or service provider. Transmissions to and from the radio 672 are conducted under control of OS 664. In other words, communications received by the radio 672 may be disseminated to the applications 667 via OS 664, and vice versa.

The radio 672 allows the system 602 to communicate with other computing devices, such as over a network. The radio 672 is one example of communication media. The embodiment of the system 602 is shown with two types of notification output devices: the LED 680 that can be used to provide visual notifications and an audio interface 674 that can be used with speaker 630 to provide audio notifications. These devices may be directly coupled to the power supply 670 so that when activated, they remain on for a duration dictated by the notification mechanism even though processor 660 and other components might shut down for conserving battery power. The LED 680 may be programmed to remain on indefinitely until the user takes action to indicate the powered-on status of the device. The audio interface 674 is used to provide audible signals to and receive audible signals from the user. For example, in addition to being coupled to speaker 630, the audio interface 674 may also be coupled to a microphone (not shown) to receive audible input, such as to facilitate a telephone conversation. In accordance with embodiments, the microphone may also serve as an audio sensor to facilitate control of notifications. The system 602 may further include a video interface 676 that enables an operation of on-board camera 640 to record still images, video streams, and the like.

A mobile computing device implementing the system 602 may have additional features or functionality. For example, the device may also include additional data storage devices (removable and/or non-removable) such as, magnetic disks, optical disks, or tape. Such additional storage is illustrated in FIG. 6B by storage 668.

Data/information generated or captured by the mobile computing device 650 and stored via the system 602 may be stored locally on the mobile computing device 650, as described above, or the data may be stored on any number of storage media that may be accessed by the device via the radio 672 or via a wired connection between the mobile computing device 650 and a separate computing device associated with the mobile computing device 650, for example, a server computer in a distributed computing network such as the Internet. As should be appreciated such data/information may be accessed via the mobile computing device 650 via the radio 672 or via a distributed computing network. Similarly, such data/information may be readily transferred between computing devices for storage and use according to well-known data/information transfer and storage means, including electronic mail and collaborative data/information sharing systems.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. For example, it should be appreciated that the surveillance and security communications platform described herein may also be utilized as an emergency notification system for vehicles. In particular, the surveillance and security communications platform may be utilized with vehicle alarm systems to automatically escalate notifications in the event a vehicle is stolen. As another example, the surveillance and security communications platform may be utilized to assist with vehicular accident notification by utilizing automatic call escalation and notification when a family member (such as a teenager) is involved in an accident. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method for utilizing a surveillance and security communications platform for automatically communicating emergency situation data to an emergency responder, comprising:
automatically opening, by a computer, one or more communications channels via any of a plurality of media streams based on at least one predefined setting for detecting a potential emergency situation; and
automatically sending, by the computer, video and audio streams to the emergency responder upon detecting the potential emergency situation.

2. The method of claim 1, further comprising monitoring a premises, via one or more of a motion sensing device and a sound detection device, for the potential emergency situation.

3. The method of claim 1, wherein automatically opening, by a computer, one or more communications channels via any of a plurality of media streams based on at least one predefined setting for detecting a potential emergency situation comprises opening a voice communication channel to the emergency responder.

4. The method of claim 1, wherein automatically opening, by a computer, one or more communications channels via any of a plurality of media streams based on at least one predefined setting for detecting a potential emergency situation comprises opening a video communication channel to the emergency responder.

5. The method of claim 1, wherein automatically opening, by a computer, one or more communications channels via any of a plurality of media streams based on at least one predefined setting for detecting a potential emergency situation comprises opening an instant messaging communication channel to the emergency responder.

6. The method of claim 1, wherein automatically opening, by a computer, one or more communications channels via any of a plurality of media streams based on at least one predefined setting for detecting a potential emergency situation comprises opening the one or more communications channels based on a setting for detecting erratic movements.

7. The method of claim 1, wherein automatically opening, by a computer, one or more communications channels via any of a plurality of media streams based on at least one predefined setting for detecting a potential emergency situation comprises opening the one or more communications channels based on a setting for detecting non-customary disruptions.

8. The method of claim 1, wherein automatically opening, by a computer, one or more communications channels via any of a plurality of media streams based on at least one predefined setting for detecting a potential emergency situation comprises opening the one or more communications channels based on a setting for detecting specific gestures.

9. The method of claim 1, wherein automatically sending, by the computer, video and audio streams to the emergency responder upon detecting a potential emergency comprises sending the video and audio streams to the emergency responder while the potential emergency situation is taking place.

10. A computer-implemented method for utilizing a surveillance and security communications platform for emergency call escalation, comprising:
detecting, by a computing device, a potential emergency situation while the potential emergency situation is occurring; and
automatically initiating, by the computer, one or more escalated emergency notifications based on a plurality of predefined settings in response to detecting the potential emergency situation.

11. The method of claim 10, wherein automatically initiating, by the computer, one or more escalated emergency notifications based on a plurality of predefined settings in response to detecting the potential emergency situation comprises activating a plurality of media streams for simultaneously communicating the notification to a plurality of receivers, the plurality of media streams comprising a telephone call, a text message, an instant messenger message, and an electronic mail message.

12. The method of claim 10, wherein automatically initiating, by the computer, one or more escalated emergency notifications based on a plurality of predefined settings in response to detecting the potential emergency situation comprises defining a predetermined number of rings, in response to an initiated telephone notification, prior to initiating another of the one or more escalated emergency notifications.

13. The method of claim 10, wherein automatically initiating, by the computer, one or more escalated emergency notifications based on a plurality of predefined settings in response to detecting the potential emergency situation comprises initiating a telephone conference call to communicate the potential emergency situation simultaneously to a plurality of predetermined recipients.

14. The method of claim 10, wherein automatically initiating, by the computer, one or more escalated emergency notifications based on a plurality of predefined settings in response to detecting the potential emergency situation comprises communicating a pre-recorded message and a written message for use as the one or more escalated emergency notifications.

15. The method of claim 10, wherein automatically initiating, by the computer, one or more escalated emergency notifications based on a plurality of predefined settings in response to detecting the potential emergency situation comprises sending a notification to a victim of the potential emergency situation.

16. The method of claim 15, further comprising sending simultaneous notifications to one or more of a plurality of family members and caregivers of the potential emergency situation upon an absence of a response to the notification sent to the victim.

17. The method of claim 16, further comprising sending a notification of the potential emergency situation to one or more social networks associated with the victim upon an absence of a response to the notification sent to the one or more of a plurality of family members and caregivers.

18. The method of claim 17, further comprising sending a notification of the potential emergency situation to one or more professional emergency responders upon an absence of a response to the notification sent to the one or more social networks.

19. A computer-implemented method for utilizing a surveillance and security communications platform for emergency detection and notification, comprising:
receiving, from a computing device, sensor data for detecting a potential emergency associated with a potential victim in one or more of a business setting and a home setting, the sensor data comprising accelerometer data, gyroscope data, motion sensor data, video data and audio data, the potential emergency comprising one or more violent gestures in the business setting and an unauthorized intrusion in the home setting; and
in response to receiving the sensor data, immediately and automatically sending, from the computing device, an emergency notification to a plurality of recipients, the emergency notification comprising a predefined text-to-speech announcement, the plurality of recipients including emergency responders, to mitigate the potential emergency associated with the potential victim.

20. The method of claim 19, wherein detecting a potential emergency situation comprises detecting the potential emergency situation while the potential emergency situation occurring utilizing one or more of a gyroscope sensor and an accelerometer sensor in the computing device to detect one or more of a shake, shock or fall associated with a user of the computing device.
